(19) United States
(12) Patent Application Publication
(10) Pub. No.: US 2008/0007088 A1
(43) Pub. Date: Jan. 10, 2008

(54) Vehicle Frame Having Energy Management System And Method For Making Same

(75) Inventor: Colin William Newport, Ontario (CA)

Correspondence Address: PATZIK, FRANK & SAMOTNY LTD., 150 SOUTH WACKER DRIVE, SUITE 1500, CHICAGO, IL, 60606, US

(73) Assignee: COPPERWELD CANADA INC., Ontario (CA)

(21) Appl. No.: 10/567,423

(22) PCT Filed: Aug. 6, 2004
(86) PCT No.: PCT/CA04/01454

§ 371 Date: Feb. 22, 2007

Related U.S. Application Data
(60) Provisional application No. 60/492,816, filed on Aug. 6, 2003.

(51) Int. Cl. B60R 21/00

(52) U.S. Cl. 296/187.03; 296/205

(57) ABSTRACT

A hollow structural member (30) for a vehicle is provided with a unitary energy absorbing end portion (34) having a reduced wall thickness (T₂), for deforming and absorbing the force of an impact, and a site for initiating such deformation. The initiation site preferably comprises a taper of the end section. A method for forming the structural members includes the steps of reducing the wall thickness of the member end section and subsequent tapering of the end section.

### BACKGROUND OF THE INVENTION

1. Field of the Invention

The present invention relates to systems and methods for absorbing energy during vehicular collision. More specifically, the invention provides vehicle frame side rails having impact energy absorbing sections and methods for forming such side rails.

2. Description of the Prior Art

Vehicle collisions, either between two vehicles or between a vehicle and a stationary object, result in tremendous forces that are transmitted through the vehicle frame, even at reduced speeds. These forces result from the transfer of kinetic energy from the moving object or objects and, if not adequately managed or absorbed, often lead to serious injury to occupants.

Most automobiles are constructed from a conventional structural frame onto which a body and other functional equipment (i.e. engine, passenger compartment etc.) are mounted. The structural frame includes, generally, a pair of side rails extending longitudinally, one on each side of the vehicle, with transversely extending crossmembers connected to the side rails to form a ladder-like arrangement. A passenger space frame is mounted on this assembly as well as a body, engine, and other elements of the vehicle. As is commonly known, bumpers are provided on the front and rear ends of vehicles and form the impact area for most types of collisions. One type of common collisions results from one or more vehicles impacting end to end, which translates the force of the impact through the side rails. Therefore, various efforts have been focussed on absorbing the kinetic energy of an impact on the ends of the side rails, prior to transference to the passenger space frame and the passengers themselves.

Various systems and methods have been proposed to absorb or dissipate the energy generated in a collision. U.S. Pat. No. 5,005,887 discloses a bumper fastening apparatus for absorbing energy transmitted from a bumper before it reaches the vehicle frame, i.e. side rails. The bumper of this reference comprises a hollow body with a core filled with a resilient foam for absorbing energy from an impact. Although minor collisions may be tolerated with this system, much of the energy is still transmitted to the vehicle frame members and, therefore, to the occupants. Furthermore, the bulky bumper required would be difficult to incorporate into specific design constraints meant to be aesthetically pleasing.

U.S. Pat. No. 6,334,518 discloses an impact absorbing mechanism for vehicles. The device comprises a hydraulic energy absorbing device positioned between the bumper and the side rails. Such a system involves additional manufacturing time and increased cost and weight to the vehicle.

U.S. Pat. No. 5,605,353 discloses a system for absorbing energy directed at a cross member before it is transmitted to the side rails.

US publication 2001/0022444 discloses specifically designed side rails including energy absorbing terminal ends. The terminal ends are provided with zones of weakness and are designed to buckle and absorb impact energy. Although effective, these terminal end structures are added components that result in production delays and added component cost.

There exists, therefore, a need for a means of controlling or managing impact energy on a vehicle that is cost effective and does not add to production time or vehicle weight.

### SUMMARY OF THE INVENTION

In one embodiment, the present invention provides a hollow structural member for a vehicle frame having a weakened end section integral therewith for absorbing energy by deformation on application of a force.

In another embodiment, the invention provides a hollow structural member for a vehicle frame having a weakened end section integral therewith for absorbing energy by deformation on application of a force and is provided with an initiation site for initiating the deformation;
wherein the end section is provided with a reduced wall thickness thereby rendering the end section weaker than the remainder of the member; and
wherein the initiation site comprises a tapered portion, with respect to the member, whereby the end section has a smaller cross sectional area than the member.

In another embodiment, the present invention provides a method for forming a hollow structural member for a vehicle frame having a weakened end section integral therewith for absorbing energy, the end section having a reduced wall thickness, the method comprising the steps of:
providing the member to be formed;
providing a first die having an opening corresponding generally with the outer dimensions of the member;
providing a mandrel for cooperating with the die, the mandrel having outer dimensions greater than the interior dimensions of the member, wherein the die is capable of sliding over the mandrel with a clearance corresponding to the desired reduced wall thickness of the member;
placing the die over the member;
moving the die over a first distance from the end of the member;
inserting the mandrel into the hollow member;
moving the mandrel over a second distance from the end of the member;
sliding the die over the member and over the mandrel thereby causing the wall thickness of the member to be reduced when the die and mandrel are in cooperation.
removing the mandrel.

### BRIEF DESCRIPTION OF THE DRAWINGS

These and other features of the preferred embodiments of the invention will become more apparent in the following detailed description in which reference is made to the appended drawings wherein:

FIG. 1 is a perspective view of a pair of side rails as known in the prior art.

FIG. 2 is side cross sectional view of an end of a side rail according to an embodiment of the present invention.

FIGS. 3 to 11 are cross sectional views of a forming process according to an embodiment of the present invention.

### DESCRIPTION OF THE PREFERRED EMBODIMENTS

### A) Energy Absorbing End Portion of Structural Members

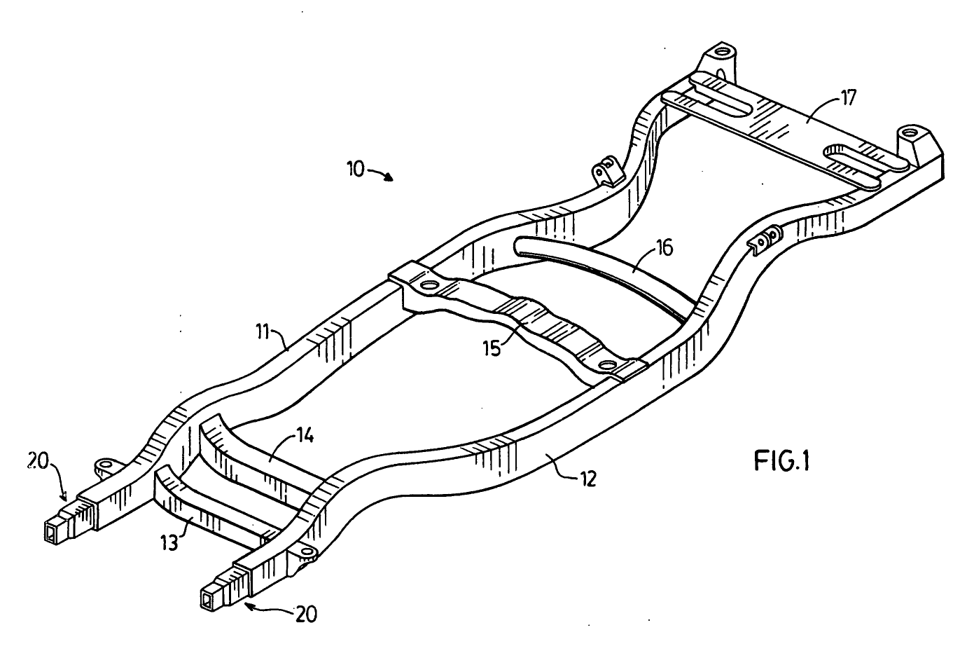

As discussed above, some of the prior art methods for energy management in automobiles involve the attachment, usually by welding, of extensions to the vehicle's side rails, wherein the extensions are engineered to be structurally weaker than the side rails. In this manner, the extensions result in a zone of weakness during a collision and are capable of buckling to absorb the energy of the impact. However, the attachment of these extensions involves extra production time for the welding operation and added material cost. Further, the welding process results in the adjacent areas becoming structurally affected by the heat and may lead to unpredictable mechanical behaviour of such sections during the collision. FIG. 1 illustrates a pair of side rails, 11 and 12, as taught in the prior art, having extensions 20 that are structurally weaker than the side rails. Such a side rail construction is taught in US patent application 2001/0022444. Generally, it is known to form members such as side rails from hollow tubes using various commonly known forming methods such as hydroforming and the like.

The present invention provides, in one embodiment, a tailored side rail for automobiles having, integral therewith, a zone of reduced strength. By avoiding the need for welding extensions etc., the present invention provides a cost and time effective solution to the energy management problem as well as a solution that is predictable in its mechanical characteristics.

The following disclosure will refer to an embodiment of the invention involving automobile side rails. However, it will be understood that this is a preferred embodiment of the invention and that the invention is not limited solely to such application. The present invention may, for example, be used for various other structural members where energy management is required. These members include vehicle structural components such as pillars, cradles etc. Further, it will also be understood that the invention can be used for either end of the side rails to accommodate front or rear impacts.

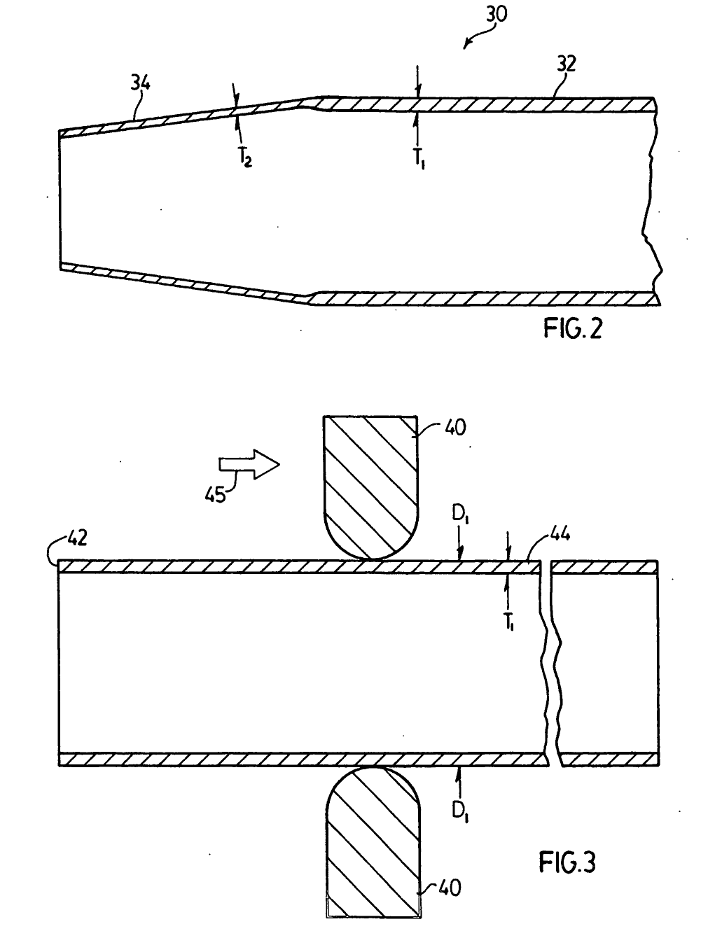

FIG. 2 illustrates an end portion of an automobile structural member, such as a side rail, according to the present invention. As can be seen, the structural member 30 comprises a hollow elongate body of any desired shape. The member 30 includes a main body 32 having a first wall thickness or gauge T₁. The member 30 also includes an energy-absorbing end portion 34 that is integral with the main body 32 but is formed of a second wall thickness T₂ that is less than T₁, thereby rendering the end portion 34 structurally weaker than the main body. Further, in accordance with a preferred embodiment, the end portion 34 is tapered as compared to the main body to enhance its energy-absorbing tendency. It will be appreciated by persons skilled in the art that although tapering of the end portion serves to provide an initiation site for energy absorption, the desired effect can also be accomplished with the thin walled section itself or a graduated wall thinning. In the result, the end portion 34 provides a zone of weakness for the member 30 so as to enable it to preferentially become physically deformed in a collision prior to transfer of impact energy to the main body of the member. As indicated above, in one preferred embodiment of the invention, the structural members 30 are side rails and one or both ends of the side rails may be provided with the above-described terminal ends. In other embodiments, other structural members (such as pillars etc.) can also be provided with terminal ends as described above.

It will be understood by persons skilled in the art that the length of the energy-absorbing end portion 34 can be calculated depending on the amount of impact absorption required. The length of the end portion will vary depending on the wall thickness chosen. For example, to absorb a given impact force, the end portion can be tailored by adjusting either or both of the wall thickness, T₂, or the length of the end portion. It will be understood that design constraints may also affect the tailoring aspect. For example, a specific design for an automobile will impose restrictions on the lengths of the side rails and, therefore, in some cases, most of the tailoring will involve adjustment of the wall thickness, T₂. The values of the length and thicknesses of the members can be determined by persons skilled in the art once the amount of energy absorption is defined. The unitary structure of the member 30 avoids any structural variables as would be found if welding processes were used to attach extensions etc. to the side rails.

### B) Method of Forming End Portions

In another embodiment, the present invention provides a method for forming the structural members described above. The method of the invention is illustrated in FIGS. 3 to 11. The method can be divided into two main stages: gauge reduction and tapering. The gauge reduction step serves to provide the structural member with a weakened end section that serves to absorb the energy of an impact by deforming. The tapering step serves to provide the structural member with an initiation site for such deformation.

### Step 1) Gauge Reduction

The gauge reduction stage is illustrated in FIGS. 3 to 7. As shown in FIG. 3, the first step of the method involves sliding a die 40 over the outer diameter of a first end 42 of a hollow tube 44 having a first wall thickness T₁ and a first outer diameter, D₁. Arrow 45 illustrates the direction of travel of the die over the stationary tube 44. As shown, the die 40 is configured for the tube in that the opening of the die generally corresponds to the outer diameter D₁ of the tube 44. Dies for this step are commonly known in the art.

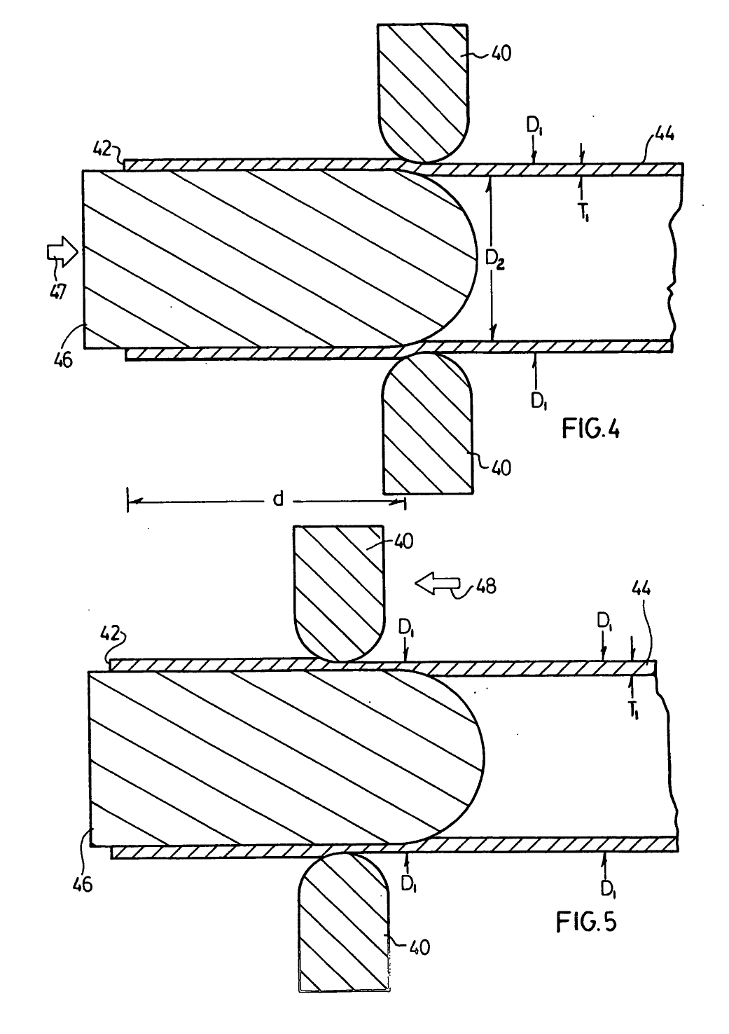

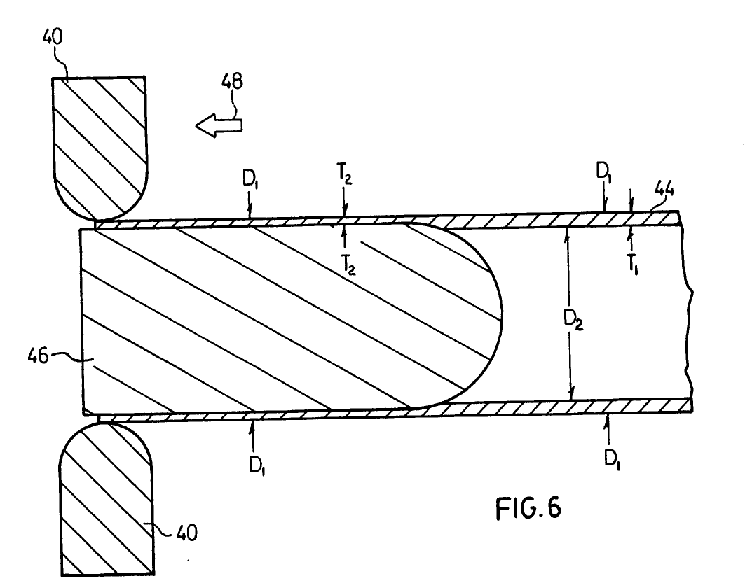

As shown in FIG. 4, the second step of the method, involves the insertion of a mandrel 46 into the lumen of the hollow tube 44, in a direction shown by the arrow 47. The mandrel is inserted over a distance “d” of the tube 44, measured from the first end 42. The distance, d, is generally and preferably, slightly shorter that the desired length of the terminal, energy absorbing portion of the structural member being formed. As explained further below, it will be understood that the mandrel can be inserted a distance greater than d and the extra length can be trimmed. However, as will be understood, this will require an added step and, therefore, may not be preferred. As shown in FIG. 4, the diameter of the mandrel 46 is preferably slightly greater than the inner diameter D₂ of the tube 44, which causes the tube 44 to expand slightly upon insertion of the mandrel 46. Moreover, as will be explained further below, the difference between the diameter of the mandrel 46 and the opening of the die 40 (the latter of which is generally equal to the outer diameter, D₁, of the tube 44) is less than the wall thickness T₁ of the tube 44. Mandrels for this step of the method are commonly known in the art.

FIGS. 5 and 6 illustrate the next step of the method wherein the die 40 is removed from the tube 44. As shown, the die 40 is slid back toward end 42 of the tube 44, in the direction shown by arrow 48, which is the opposite direction of arrow 45 shown in FIG. 3. As shown in FIG. 5, as the die 40 is removed, it passes over the mandrel 46, which remains in place within the tube 44. In the result, the wall thickness of the tube 44 is forcibly reduced to a thickness T₂, which corresponds generally to the clearance between the diameter of the mandrel 46 and the opening of the die 40. It is noted that the outer diameter D₁ of the tube 44 is maintained constant since, as indicated above, the die is configured to have an opening generally corresponding to the outer diameter D₁ of the tube 44.

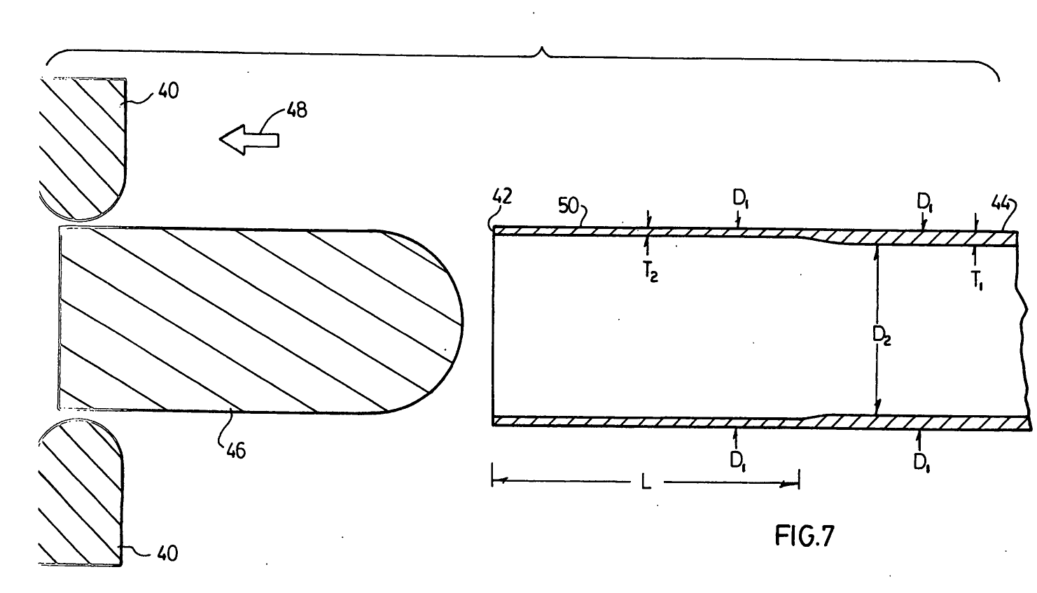

FIG. 7 illustrates the final step of the gauge reduction stage of the method wherein, once the die 40 is removed, the mandrel 46 is also withdrawn from tube 44, in the direction 48. As shown in FIG. 7, the result of the removal of the die 40 and mandrel 46 is a tube 44 having a thin walled end portion 50. The wall thickness of the end portion 50 is shown as T₂. As shown, the outer diameter D₁ of the end portion 50 is preferably generally the same as that of the remainder of the tube 44. The end portion 50 of the tube 44 is of a length L, which is, as discussed above, generally longer than d, the distance the mandrel is inserted, due to the fact that the length of the tube is normally increased during the gauge reduction process. As indicated above, in the preferred embodiment, L corresponds generally to the desired length of the end energy-absorbing portion of the structural member being formed. However, in the event that L is longer than such desired length, the excess can be trimmed.

### Step 2) Tapering

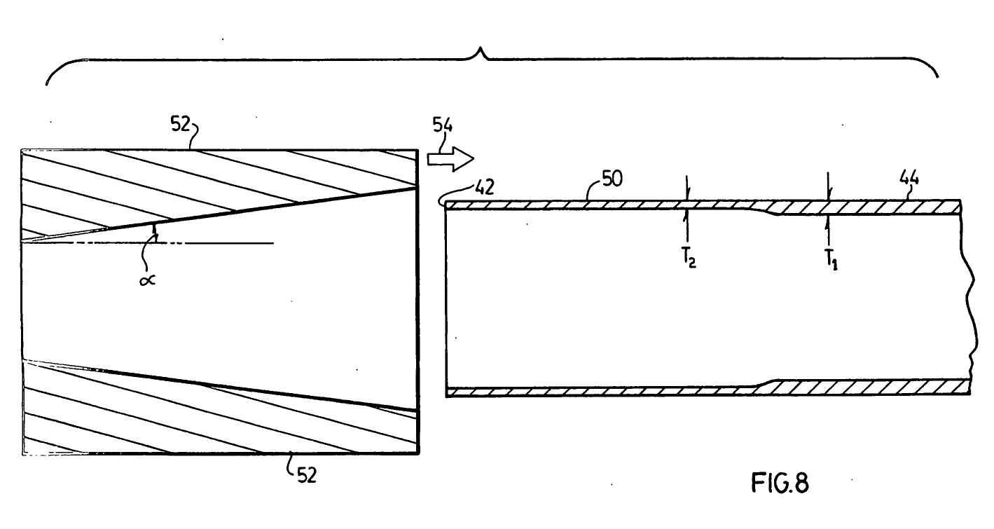

FIGS. 8 to 11 illustrate the steps of the tapering the tube 44 following gauge reduction. In the first step, as shown in FIGS. 8, a tapered die 52 is advanced towards the end 42 of the tube 44. It is noted that end 42 is the reduced wall thickness end portion 50 of the tube 44. As shown in FIG. 8, the tapered die 52 is advanced towards the stationary tube 44 in the direction shown by arrow 54. The die 52 includes a taper of an angle α, which will vary depending on the required tapering of the tube 44. The specific geometry of the tapering die 52 will be apparent to persons skilled in the art based on the need.

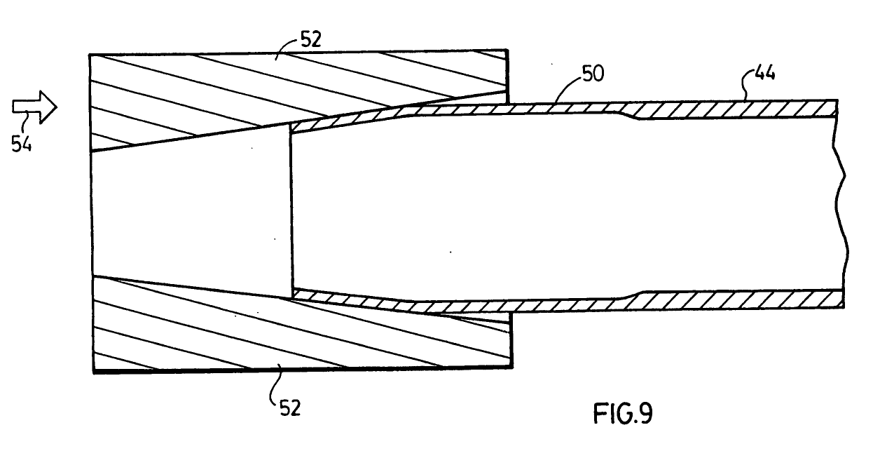

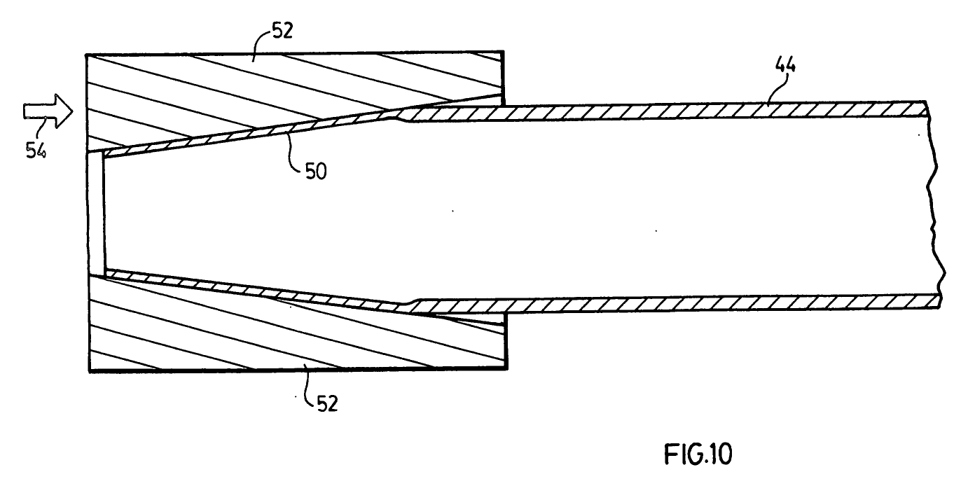

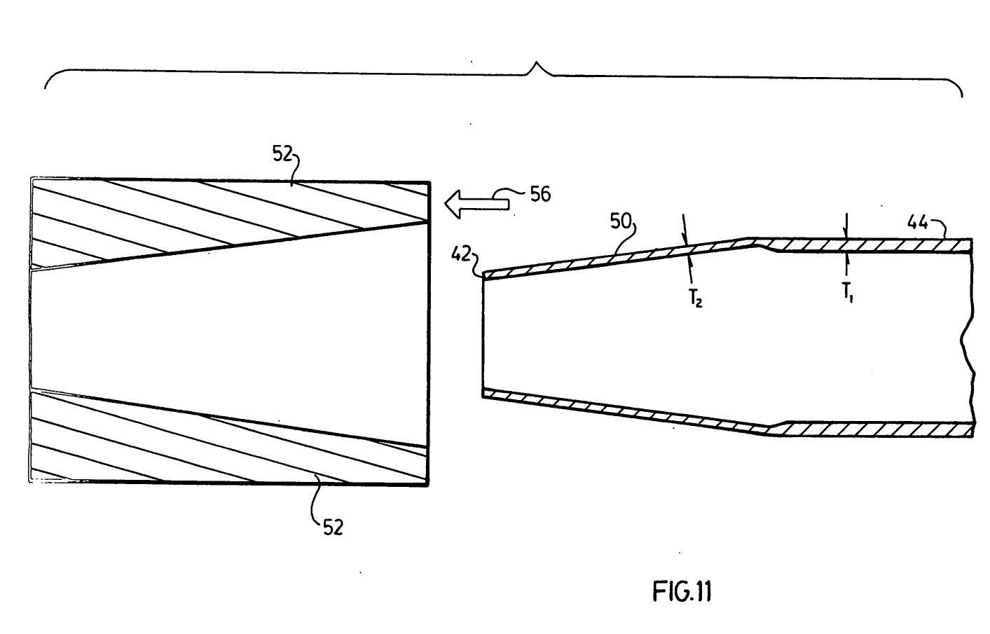

As shown in FIGS. 9 and 10, as the tapered die 52 is advanced over the end portion 50 of the tube 44, the end portion 50 is gradually reduced in diameter to provide the tube 44 with a tapered end.

In FIG. 11, the tapered die 52 is shown being withdrawn off the end portion 50 of the tube 44 in the direction shown by arrow 56. The resulting tube 44 includes an end portion 50 having a reduced wall thickness T₂ and a tapered outer diameter. As explained above, the reduced wall thickness of the end portion 50 is structurally weaker than the remainder of the tube 44 and, therefore, is more susceptible to deformation during an impact on end 42. As such, the end portion 50 serves to absorb the energy of an impact prior to it being transferred to the remainder of tube 44. Furthermore, the tapering of the end portion 50 aids the initialization of the deformation process.

The tube 44, after being tapered may then be formed to the desired final shape of the structural member using any conventional process such as hydroforming etc. It will be understood that the above description refers to “diameters” of the tube and end portions. However, it will be understood that the above forming process can also be conducted on a pre-formed member having another geometry. In such case, the dies and mandrel discussed above will have the respective shapes of the member being formed. For example, the die and mandrel may have a square or rectangular design should the final tube have such geometry.

As mentioned above, the preferred structural member of the present invention includes an energy absorbing and unitary end portion having a thinned wall and tapered outer diameter. However, it will be appreciated by persons skilled in the art that the end portion can optionally include only one of these structural features and still provide the desired energy absorbing capacity. For example, the end portion can have either a thinned wall (where no deformation initiation site is needed) or a tapered outer diameter or geometry (where the initiation site alone serves to deform the end of the member). In such case, only the needed forming stage (i.e. either gauge reduction or outer dimension tapering) would be followed.

In another embodiment, the tapered section of the members can be provided along only a portion of the reduced wall thickness region while still serving to initiate deformation.

Further, in another embodiment, the members of the invention can include a reduced gauge as described above and, instead of a taper, they can be provided with another form of initiation site for impact absorption. An example of an initiation site is the provision of a fold in the tube end wall as known in the art.

Although the invention has been described with reference to certain specific embodiments, various modifications thereof will be apparent to those skilled in the art without departing from the spirit and scope of the invention as outlined in the claims appended hereto.

1-17. (canceled)

18. A unitary hollow structural member for a vehicle frame, the member comprising:
a body with a generally constant first wall thickness; and
a first end adapted to be axially deformed upon application of a force on said first end, said first end including a weakened section having a generally constant second wall thickness, wherein said second wall thickness is less than said first wall thickness, and said first end further including a deformation initiation site comprising a tapered portion, wherein the cross sectional area of said member is gradually reduced along an axial direction towards said first end.

19. The structural member of claim 18 wherein the entire length of said tapered portion comprises the second wall thickness.

20. The structural member of claim 18 wherein said structural member comprises a vehicle frame side rail, cradle, or pillar.

21. The structural member of claim 19 wherein said structural member comprises a vehicle frame side rail, cradle, or pillar.

22. A method for forming a hollow structural member for a vehicle frame and having a weakened end section integral therewith for absorbing energy, said end section having a reduced wall thickness, the method comprising the steps of:
providing a tubular member to be formed, the tubular member having a generally constant first wall thickness and a first end to be provided with said weakened portion;
providing a first die having an opening corresponding generally with the outer dimensions of the tubular member;
providing a mandrel capable of being inserted within the said first die opening, the clearance between said mandrel and the die opening corresponding to a desired second wall thickness of the tubular member;
placing the tubular member within the first die opening and axially moving the first die over a first length of the tubular member;
inserting the mandrel into the first end of the tubular member along a second length of the tubular member less than the first length, said second length comprising the length of the end section;
sliding the first die over the tubular member and over the mandrel thereby causing the wall thickness of the tubular member first end to be reduced to the generally constant second wall thickness;
extracting the mandrel from the tubular member;
providing a second die having a tapered die opening with an inlet section having the larger diameter;
introducing said tubular member first end into the inlet section of the second die opening and forcing constriction of said first end section to assume the shape of the second die opening while maintaining said second wall thickness.

23. The method of claim 22 wherein said structural member comprises a vehicle frame side rail, cradle, or pillar.
